(19) United States
(12) Patent Application Publication
(10) Pub. No.: US 2010/0024020 A1
(43) Pub. Date: Jan. 28, 2010

(54) Wireless mobile device with privacy groups that independently control access to resident application programs

(76) Inventors: Ernest Samuel Baugher, Buda, TX (US); Venkata Chalapathi Majeti, Naperville, IL (US); Suresh Neelagaru, Amarillo, TX (US)

Correspondence Address: Carmen Patti Law Group , LLC, ONE N. LASALLE STREET, 44TH FLOOR, CHICAGO, IL, 60602, US

(21) Appl. No.: 12/317,187

(22) Filed: Dec. 19, 2008

Related U.S. Application Data
(63) Continuation-in-part of application No. 12/220,135, filed on Jul. 22, 2008.

(51) Int. Cl. H04L 9/32; G06F 21/00

(52) U.S. Cl. 726/7

(57) ABSTRACT

An exemplary method implemented by a wireless mobile device controls user access to programs and files defining items that are resident on the mobile device. A first icon associated with a corresponding first program installed on the wireless mobile device is displayed on the screen of the wireless mobile device, where the first icon can be seen by any person using the wireless mobile device and the corresponding first program is available for execution to said person. A privacy gate and a corresponding privacy icon displayed on the screen are created using a privacy interface program installed on the wireless mobile device. A password associated with the privacy gate is entered by a first user so that a subsequent request by a user to traverse the privacy gate will require entry of this password. The first program and the privacy gate are linked so that a user must traverse the privacy gate in order to execute the first program.

### CROSS REFERENCE TO RELATED APPLICATION

This is a continuation-in-part application that claims the benefit of the prior filed U.S. patent application Ser. No. 12/220,135 filed Jul. 22, 2008 entitled “Wireless Mobile Device with User Selectable Privacy for Groups of Resident Application Programs and Files”.

### BACKGROUND

This invention relates to mobile communication devices capable of executing a plurality of application programs as individually selected by a user such as by selection of indicia, e.g. an icon displayed on a screen, associated with each application program. It is more specifically directed to independent privacy protection groups each containing different application programs and/or files, where each privacy protection group has a separate password that must be entered by a user to gain access to application programs and/or files contained in the subject group.

Cellular telephones that are multimedia message service (MMS) and/or short message service (SMS) capable can run a variety of resident application programs beyond basic voice communications. Functions such as address books, contact lists, internet browser, calendar appointments, document and multimedia folders, etc. are each typically represented by icons displayed on the screen of the cellular telephone or personal digital assistant. To access a particular function, the user can highlight or point and click on an icon displayed on the screen associated with the fimction/application desired to be accessed.

Because cellular telephones are viewed as one user's personal item, only limited security in terms of controlling access to its communication capabilities and resident functions are available. For example, a keypad lock function is available by which the keypad and/or display are locked from usage until a password, e.g. the entry of one or more characters, predetermined by the handset manufacturer or service provider has been entered. This serves to prevent the unintended activation of any function/service such as by an inadvertent key depression while the telephone is carried in one's pocket or purse. It also serves to prevent someone who does not know the password from operating/accessing any functions of the telephone. However, once the password is entered, all the capabilities (applications and services) of the telephone are made available.

### SUMMARY

One object of the present invention is to provide a mobile device with independent privacy protection groups each containing different application programs and/or files, where each privacy protection group has a different password that must be entered to gain access to application programs and/or files contained in the subject group. Thus, multiple users of the same mobile device are each provided with independent control of access to the applications and/or files contained in different privacy groups based on the respective passwords known to each user. For example, one user may only have access to a first privacy group, and another user may have access to other privacy groups. All users will have access to applications and/or files that reside in a public domain, i.e. not in any privacy group.

An exemplary method implemented by a wireless mobile device controls user access to programs and files defining items that are resident on the mobile device. A first icon associated with a corresponding first program installed on the wireless mobile device is displayed on the screen of the wireless mobile device, where the first icon can be seen by any person using the wireless mobile device and the corresponding first program is available for execution to said person. A privacy gate and a corresponding privacy icon displayed on the screen are created using a privacy interface program installed on the wireless mobile device. A password associated with the privacy gate is created and entered by a first user so that a subsequent request by a user to traverse the privacy gate will require entry of this password. The first program and the privacy gate are linked so that a user must traverse the privacy gate, by entry of the correct password, in order to execute the first program.

Another exemplary embodiment of the invention includes the wireless mobile device that substantially implements the above method.

A further exemplary embodiment of the invention includes an article with computer readable instructions that substantially implement the above method.

### DESCRIPTION OF THE DRAWINGS

Features of exemplary implementations of the invention will become apparent from the description, the claims, and the accompanying drawings in which:

FIG. 1 is a block diagram of an exemplary system suited for support of a mobile device that incorporates an embodiment of the present invention.

FIG. 2 is a block diagram of an exemplary wireless mobile device in accordance with an embodiment of the present invention.

FIG. 3 is a flow chart illustrating steps of an exemplary method of an initial registration and acquisition of a privacy interface program in accordance with an embodiment of the present invention.

FIG. 4 is a flow chart illustrating steps of an exemplary method of installation of a privacy interface program in accordance with an embodiment of the present invention.

FIG. 5 is a flow chart illustrating steps of an exemplary method for processing an initial request by user for access to an application/data file.

FIG. 6 is a flow chart illustrating steps of an exemplary method for determining whether a group password is required to gain access to an application/data in accordance with an embodiment of the present invention.

FIG. 7 is a flow chart illustrating steps of an exemplary method for requiring re-entry of a password to regain access to an open privacy item after a period of inactivity in accordance with an embodiment of the present invention.

FIG. 8 is a flow chart illustrating steps of an exemplary method of selecting an application or file for privacy protection in accordance with an embodiment of the present invention.

FIG. 9 is a partial front view of an exemplary mobile device in which a privacy protected item is attempted to be accessed in accordance with an embodiment of the present invention.

FIGS. 10-13 are partial front views of the screen of an exemplary mobile device in accordance with the present invention in which two users share the device and each requires privacy for certain applications.

### DETAILED DESCRIPTION

One aspect of the present invention resides in the recognition of the difficulties associated with controlling privacy with the shared use of a mobile device. For example, the owner of a mobile device may occasionally lend it to a friend, acquaintance, or co-worker for temporary use. Or a group of users may elect to share one mobile device. However, there is a concern about the privacy of certain functions and/or data, especially an address book, contact list, list of previous phone numbers called, a call log of people called or calling, application that accesses one's bank or brokerage account, etc. A primary user may not want to make such functions/data available to be accessed by another who may be given occasional access to the same mobile device. Further, there may be special application programs and/or data files for which the primary user is authorized, where these programs/data files would be inappropriate to be made accessible to others who might temporarily use the mobile device. For example, a primary user or owner might desire to temporarily loan his mobile device to a friend to enable the friend to make a one or more phone calls. However, without privacy control as provided herein, the friend could also access the owner's programs/functions/data files. Thus, there is a need to ensure the primary user's privacy on a selectable function/program/file basis so that a mobile device can be temporarily used by another without fear of undesired access to private functions/programs/files.

Further, multiple users of the same mobile device may have mutually exclusive privacy concerns. That is, each user may require privacy of certain applications/files so that the certain applications/files cannot be accessed by the other users. This need can be satisfied by providing each user with at least one privacy group with a corresponding password where the password for the privacy group is known only to the corresponding user. This can be accomplished without the need to lock all applications/files resident on the mobile device. For example, some applications, i.e. basic phone calls, can be made available to all users by the application residing in a public domain, e.g. the phone call application not residing in any privacy group. Alternatively, a set of applications and/or files for accessing the first user's bank account can reside in a first privacy group with a password known only by the first user, while another set of applications and/or files for accessing a second user's stock trading account can reside in a second privacy group with a password known only by the second user, all on the same shared mobile device. The privacy group can accommodate differing granularity, e.g. users can utilize a privacy group to protect one or more applications, or the user can elect to utilize a privacy group to provide privacy for entries (people) on a contact list where privacy protection is elected on a contact by contact basis.

A privacy application installed on the mobile device supports the creation and control of concurrently displayed independent privacy groups. Each privacy group controlled by the privacy application acts as a filter that must be traversed by entry of the corresponding password in order to access any applications and/or files residing in the associated privacy group. In a preferred embodiment, a user can establish a desired privacy group, e.g. represented by a displayed icon on the screen of the mobile device, and move applications and/or files residing in the public domain (with corresponding icons) into the privacy group by using a drag and drop graphical user interface technique. Performing this action causes such applications and/or files which were publicly accessible to now be accessible only through the privacy group. The icons for the protected applications and/or files are no longer displayed on the screen as these were previously displayed in the public access region of the screen. Thus, applications and/or files residing on the mobile device which had no prior relationship to the privacy application can be brought under a protection umbrella of a privacy group. Alternatively, a privacy group can provide protection for applications and/or files by selection of the items to be protected from a displayed list menu of applications and/or files in which the user checks a corresponding check box or selects corresponding displayed icons or names.

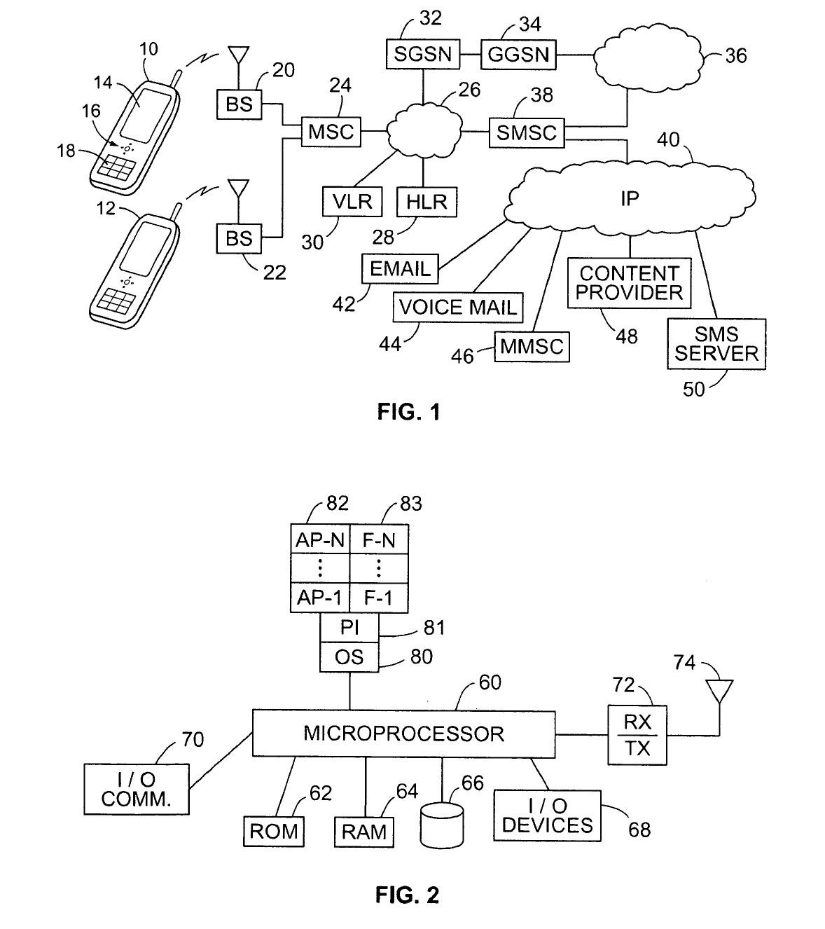

Referring to FIG. 1, an exemplary telecommunication network includes a system that supports wireless cellular subscribers with voice communications, multimedia message service (MMS) and/or short message service (SMS) messaging. First and second subscribers utilize mobile devices 10 and 12 such as a cellular telephone with these capabilities. As used herein, a mobile device means a wireless portable two-way communications apparatus intended to be held in one hand during normal operation, e.g. a cellular telephone or personal digital assistant (PDA), and does not include a laptop computer. Each exemplary mobile device includes a display screen 14, user input controls 16 associated with cursor and screen control, and a keypad and/or keyboard 18 for accepting additional user inputs.

The system includes base stations (BS) 20 and 22 that support wireless communications between the devices 10 and 12, respectively, as controlled by a mobile switching center (MSC) 24. Signaling and data information are carried to and from the MSC by a supporting communication system 26, e.g. signaling system 7 (SS7). Also coupled to the system 26 is a home location register (HLR) 28 and a visiting location register (VLR) 30 which facilitate registration, authentication and location information related to the mobile devices.

In this illustrative example, communications are provided by a general public radio service (GPRS). Accordingly, communications with a serving GPRS service node (SGSN) 32 is also supported by system 26. Communications between the SGSN 32 and other networks 36, e.g. public switched telephone network (PSTN), general services mobile (GSM) network or code division multiple access (CDMA) network, is facilitated by a gateway GPRS service node (GGSN) 34.

A SMS controller (SMSC) 38 is coupled to system 26 and supports SMS communications among the mobile devices 10/12 and other devices which may be coupled to the internet protocol (IP) network 40. The mobile devices 10/12 may also support other communication services such as MMS, email, a browser for internet access, and/or other data applications. A variety of services, functions and apparatus may be connected to the network 40. For example, servers or other appropriate nodes may provide email service 42 and voice mail service 44 for the mobile devices. A multimedia message service center (MMSC) 46 may provide support for multimedia communications, e.g. pictures or video information. A content provider server 48 is merely illustrative of the many possible sources of information which are available over the Internet. An SMS server 50 provides an interface between communications utilizing the SMS protocol and other communication protocols such as packets transmitted over the Internet.

FIG. 2 is a block diagram of an illustrative embodiment of a mobile device, e.g. mobile device 10. The functionality of the mobile device is provided by microprocessor 60 which is supported by read-only memory (ROM) 62, random access memory (RAM) 64, and nonvolatile memory 66 such as flash memory, EEPROM, etc. Input/output (I/O) devices 68 may include input devices such as a keypad, keyboard, touchpad, and other buttons such as for cursor movement, screen selection, etc., microphone, and an input port jack for wire-based communications with other devices. The output devices include a display screen 14 and a speaker. A separate microprocessor (not shown) can be dedicated to rendering the video display if the computational load for creating images is too high for the primary microprocessor 60 to handle in addition to the other demands. An input/output communication module 70 supports two-way communications between the microprocessor 60 and external devices such as connected by a cable to the input port jack, by infrared (IR) beam, or by Bluetooth technology. A transmit and receive module 72 coupled to antenna 74 provides radio frequency (RF) communication support with base stations and/or other wireless devices such as by Wi-Fi. The microprocessor 60 operates under the control of an operating system (OS) 80 which provides basic operational functionality, e.g. Symbian, Windows Mobile, Palm, RIM, iPhone, etc. The OS supports application programs 82 that provide higher-level functionality, files 83 that may contain various user information, and privacy interface (PI) application 81. The PI application 81 functions as “middleware”, i.e. software that provides an interface between the OS, e.g. user inputs, and the higher level applications 82 and files 83. As explained below, the PI application 81 enables the user to create a first group of certain selected applications 82 and files 83 that can be accessed only after the entry of a predetermined password (privacy protected) while permitting applications and files not within the first group to be accessed without the need for the entry of the password (public or not privacy protected). The same valid password operates to protect all of the applications/files that are privacy protected by one privacy group. If the user desires, different privacy groups with different corresponding passwords can provide protection to different applications/files. The microprocessor in combination with associated memory and other peripheral devices form a microprocessing unit. The PI function can also be incorporated within the OS. Middleware as defined herein refers to the privacy interfacing software function whether disposed intermediate to the applications to be privacy protected and the OS, or incorporated within the OS itself for purposes of controlling access to specific applications.

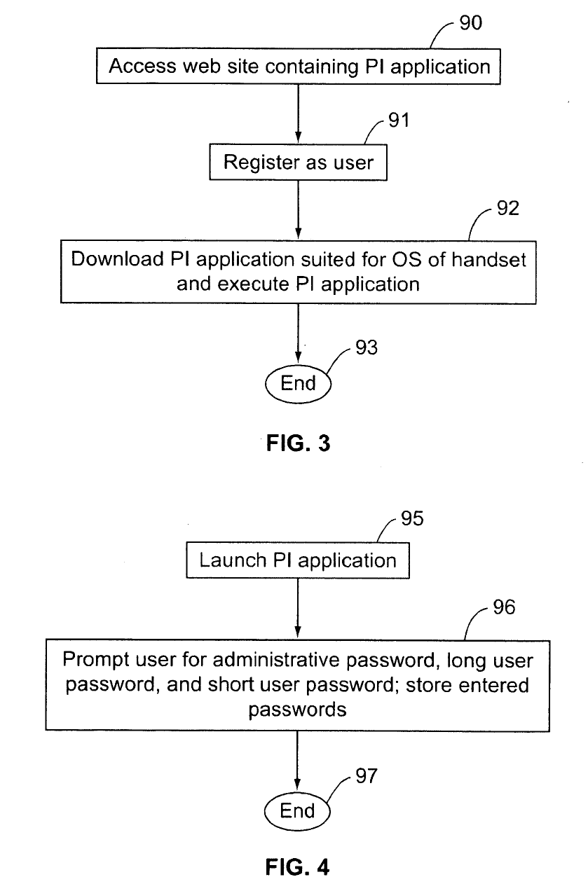

FIG. 3 shows exemplary steps for an initial registration and acquisition of the privacy interface program. In step 90 a user preferably uses his mobile device to access a web site containing the privacy interface application. In step 91 the user is requested by the web site for registration information, e.g. name, address, email address, etc. and completes the registration process by providing the requested information. If a payment is required in order to download the privacy interface application, the user can be given the option to provide payment such as by use of a credit card. In step 92, after having successfully completed the registration process, the privacy interface application suited for use with the operating system of the user's mobile device is downloaded to the mobile device which then executes the downloaded program causing it to be installed as middleware 81 as shown in FIG. 2. The user may be queried as to the manufacturer and model of his mobile device during the registration process in order to identify the appropriate privacy interface application compatible with the particular operating system of his mobile device. Alternatively, the identification of the OS and its version could be retrieved direct from the user's handset, i.e. without manual entry by the user, by a query from the web site if such information is stored and made available by the handset. This process terminates at END 93.

FIG. 4 shows illustrative steps of an exemplary method in which the installed privacy interface program is configured with passwords. In step 95 the user launches the privacy interface application such as by clicking on an associated icon displayed on the screen of his mobile device. Because this is the first execution of the privacy interface application on the user's mobile device, an initial configuration of passwords to be selected by the user is needed. In step 96 the privacy interface application prompts the user to enter an administrative password, a long user password, and a short user password. These passwords are stored in nonvolatile memory for use in association with the provided privacy feature. The administrative password is required in order to be given access to later change the long and short passwords. The long password consists of a series of alphanumeric characters selected by the user, and preferably consists of 6 or more characters, e.g. 6-12 characters. The short password consists of a different series of alphanumeric characters selected by the user, and preferably consists of 4 or fewer characters, e.g. 2-3 characters. In accordance with an embodiment of the present invention, the entry of the long password is initially required to gain access to an application or file in the privacy protected group. Once a privacy protected application or file has been opened/accessed, inactivity by the user as determined by a lack of user input within predetermined time intervals, will cause the need to reenter a password upon an attempt by the user to again access the privacy protected open application. Whether the entry of the long or short password is required depends upon the time interval of inactivity. This is explained in more detail below. Alternatively, the privacy interface can support a “no timeout” feature in which inactivity by the user will not trigger a timeout requiring entry of the password. In this case, the user can manually exit a privacy group to provide privacy protection for applications/files therein. Turning off the device, i.e. powering down, will preferably exit all privacy groups so that upon start up of the device each privacy group will require password entry to access protected items. This process terminates at END 97.

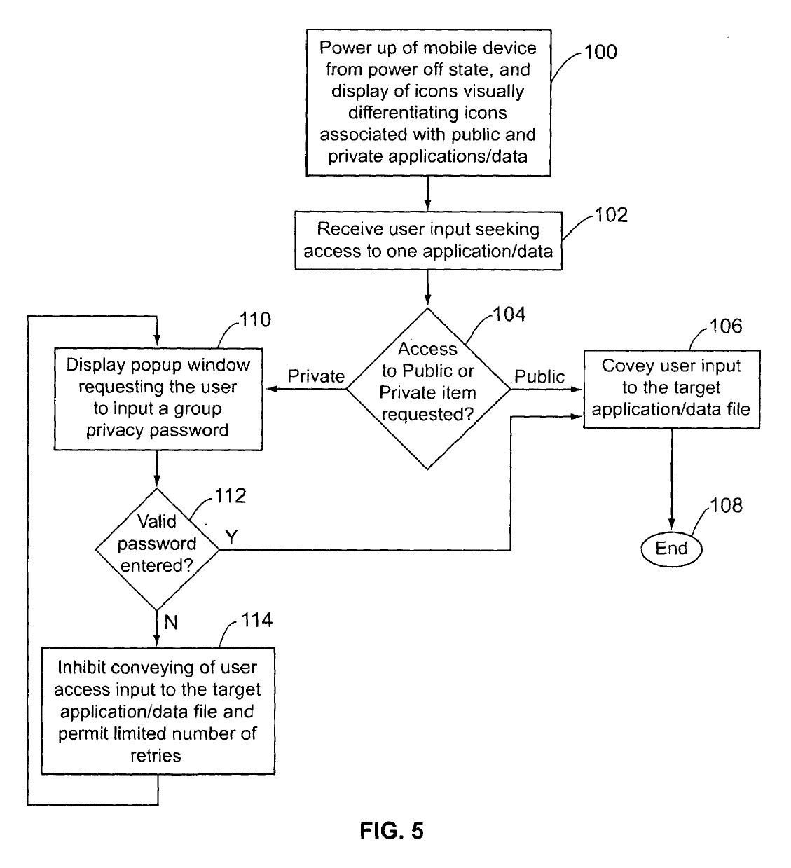

FIG. 5 shows exemplary steps by which an initial request by user for access to an application/data file is processed. Upon the powering up of the mobile device from a power off state, icons associated with the resident applications/data files are displayed on the screen differentiated based on whether each icon is associated with a public or private group as shown in step 100. As described below, icons (and the associated applications/data files) can be selected by the user to be either public or private. In step 102 a user input is received by which the user seeks access to one of the applications/data files. For example, the user may have used the cursor to select and click on an icon associated with the target application/data file. In step 104 a determination is made of whether the user requested access is to a public or private application/data file. Upon determination that the request is for access to a public item, the privacy interface middleware conveys the user input of the request to the target application/data file at step 106. This will typically result in the opening of the target application/data file. This results in this process terminating at END 108.

A determination at step 104 that the requested access is to a private item results in step 110 causing a pop-up window to be displayed requesting that the user input a previously determined group privacy password. In step 112 a determination is made of whether a valid group password has been entered by the user. A YES determination by step 112, indicating that the correct password has been entered, results in further processing by step 106 in which the user access input is conveyed to the target application/data file. A NO determination by step 112 results in the privacy interface middleware inhibiting the conveying of the requested user access to the target application/data file. It will be apparent that by inhibiting the transmission of the user's access request to the target application/data file that the latter cannot be opened/accessed, thereby providing privacy against unauthorized access and/or use of privacy protected applications/data files. The user may be permitted a predetermined number of further attempts to enter a valid group password upon the entry of an incorrect group password. This process continues by returning to step 110 to permit further attempts to enter a valid group password. This process will terminate either upon the entry of a valid group password or upon the maximum number of retries being exceeded.

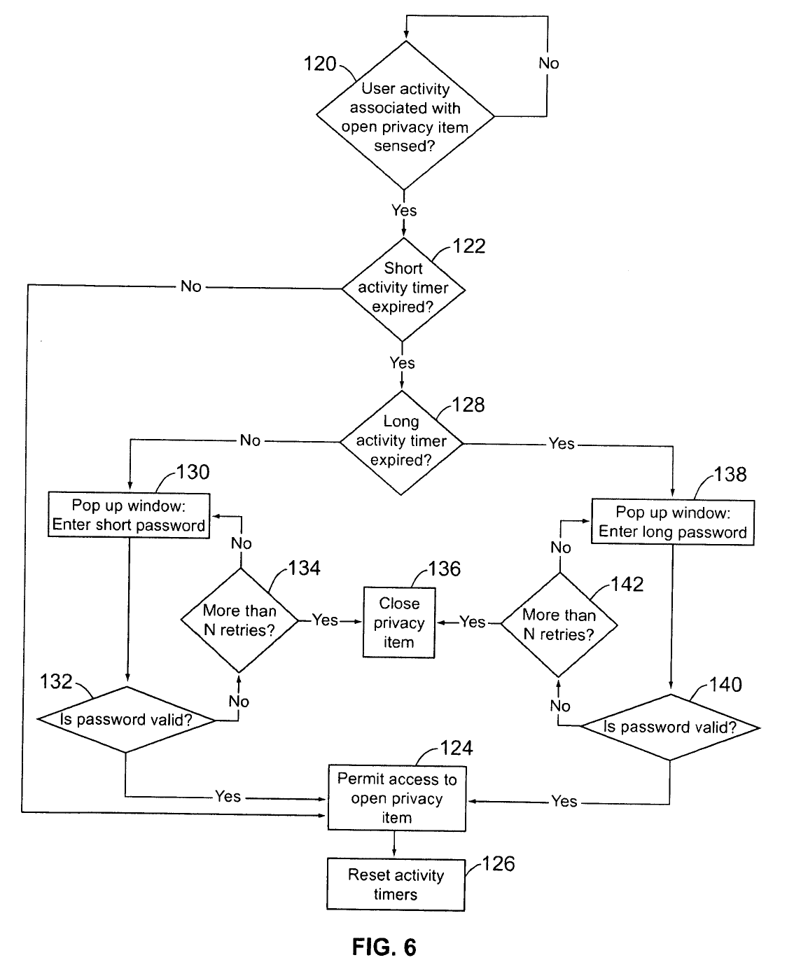

FIG. 6 illustrates steps of an exemplary method for requiring entry of a password to regain access to a previously opened privacy item after a period of inactivity by the user. In step 120 a determination is made of whether user activity associated with an open privacy item has been sensed. A NO determination loops back to the beginning of this determination effectively waiting for user activity associated with an open privacy item to be sensed. A YES determination results in step 122 determining if the short activity timer has expired, i.e. if the time interval since the last user activity associated with an open privacy item exceeds a first predetermined time. A NO determination by step 122, indicating that the user activity associated with the open privacy item did not exceed the first predetermined time, results in the user being permitted access to the open privacy item as indicated in step 124. This process then terminates with the activity timers being reset as indicated at step 126.

A YES determination by step 122 results on a further determination by step 128 of whether the long activity timer has expired, i.e. if the time interval since the last user activity associated with an open privacy item exceeds a second predetermined time that is longer than the first predetermined time. A NO determination by step 128, indicating an expiration of the short activity timer but not the long activity timer, results in the generation of a pop up window requesting the user to enter the short password in step 130. In step 132 a determination is made of whether the password entered by the user is valid. A YES determination, i.e. the entered password is valid, results in processing by steps 124 and 126 as explained before. A NO determination in step 132, i.e. an incorrect password was entered, results in step 134 determining if the user has attempted more than N attempts to enter the correct password. A NO determination the step 134 returns processing to step 132 provide the user with another opportunity to enter the correct password. A YES determination by step 134, i.e. the user has exceeded N attempts to enter the correct password, results in the privacy item being closed at step 136 and concludes processing of this privacy protection algorithm.

A YES determination by step 128 results in the generation of a pop up window requesting the user to enter the long password as indicated in step 138. In step 140 a determination is made of whether the entered long password is valid. A YES determination results in further processing by steps 124 and 126 as explained above. A NO determination by step 140 results in a determination at step 142 of whether user has made more than N attempts to enter the correct long password. A YES determination by step 142, indicating that the user has made more than N attempts without entering the correct on password, results on the privacy item being closed and concludes processing of this privacy protection algorithm at step 136. A NO determination by step 142, indicating that the entered password is not a valid long password but that fewer than N attempts to enter the correct long password have been made by the user, results in processing returning to step 138 thereby providing the user with another attempt to enter the valid long password. For example, the long and short predetermined time intervals could be 6 minutes or more, and 2-5 minutes, respectively.

Inhibiting access to an opened privacy protected item following a time interval of user inactivity is utilized to further enhance the privacy protection. For example, should the user's attention be required for other purposes after having opened a privacy protected item, it is possible that the user may not close the open item and leave the mobile device at a location accessible to others. Causing the entry of a password following a period of user inactivity helps to mitigate against such a potential breach of privacy.

The use of both a long and short time interval with corresponding requirement for the entry of a long and short password promotes privacy protection while minimizing the burden to the authorized user. The user of the mobile device may be in an environment in which it is difficult to utilize both hands to input characters or where the user is only able to devote intermittent periods of attention to use of the mobile device. In such situations, it is desirable to minimize the burden on the user in entering a password following a short interval in which no user inputs were made to the mobile device. It is relatively easy to enter 2 or 3 characters, and since the user can select the characters that make up the short password, the user should be easily able to enter the short password quickly using only one hand so as to minimize the burden of entering the password. Because a password utilizing only 2 or 3 characters provides substantially less security than a password made of six or more characters, the entry of a long password is required if the predetermined long time interval is exceeded. This is believed to strike a desired compromise between security provided by the password and burden borne by the user.

In one embodiment of the present invention, all applications and files resident on the mobile device are automatically included for privacy protection upon the first execution of the privacy interface application. In an alternative embodiment, applications and files resident on the mobile device are not protected by the privacy interface application until the user selects the application or file to receive privacy protection. For example, applications and files existing on the mobile device when the privacy interface application is first downloaded and executed are not automatically included within privacy protection.

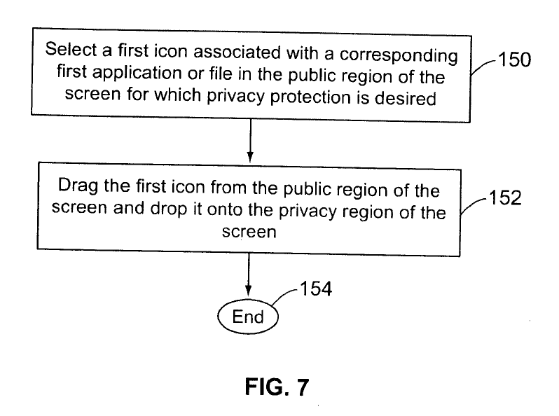

In one embodiment the screen of the mobile device, upon the privacy interface application having been executed, is segregated into a privacy protected region and a public region, i.e. a region in which resident icons do not receive privacy protection so that any person with access to the mobile device can execute and obtain access to applications and files with icons in the public region. FIG. 7 shows exemplary steps for enabling privacy protection for a selected application or file. In step 150, the user selects a first icon associated with a corresponding first application or file, where the first icon is in the public region and for which privacy protection is desired. In step 152 the user drags the first icon from the public region of the screen and drops the first icon onto the privacy region of the screen. This action is sensed by the privacy interface application which alters accessibility to the subject application or file to provide privacy protection. Applications and files that are designated to receive privacy protection have user inputs that are routed through the privacy middleware 81. Before a user input intended for a privacy protected application or file is routed by the middleware to the subject application or file, the privacy interface application determines if a valid password has been entered within a required long/short time interval. The intended user input is allowed to be routed to the corresponding application or file to gain access to it only if the password criterion is satisfied, thereby protecting access to the applications and files. Alternatively, the privacy interface can add a selectable menu choice that can be accessed by clicking on an icon of the application/file to bring up a displayed menu where a “make private” choice can be selected by the user.

It is preferable that the icons associated with privacy protected applications/files be visually differentiated on the screen, i.e. have a common visual differentiation trait, from the icons associated with public (non-privacy protected) applications/files. Such differentiation can be accomplished by utilizing different color backgrounds for two regions on the screen or by drawing a line to segregate the different regions. This permits the user to easily discern which applications and files have privacy protection, and which do not. Alternatively, the icons associated with the different applications and files can be individually differentiated to indicate whether privacy protection is provided or not, such as by utilizing a color, e.g. green, for icons with privacy protection and a different color, e.g. red, for icons that are not privacy protected, or by other indicia such as displaying a common symbol, e.g. a key symbol, adjacent to or part of each icon that has privacy protection.

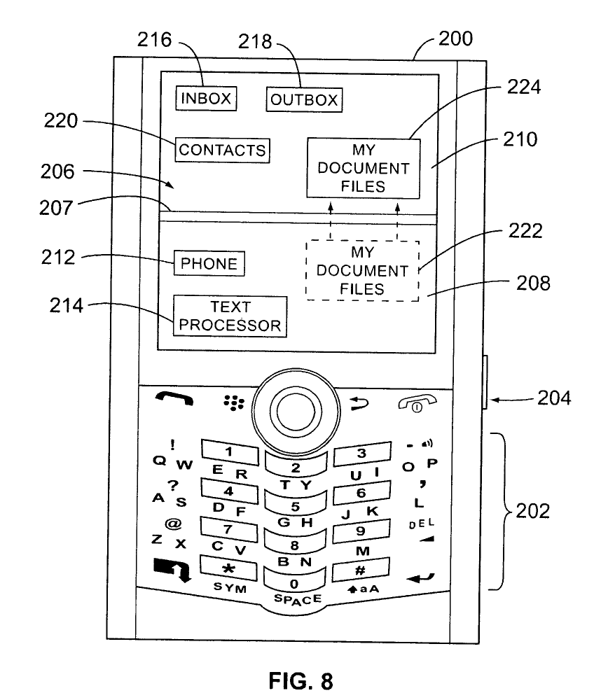

FIG. 8 shows a partial front view of an exemplary mobile device in which a data folder is being selected for privacy protection. An exemplary MMS capable mobile device 200 includes a keypad 202 enabling the user to input alphanumeric characters and a variety of command and control buttons 204 including the ability to control a cursor that allows icons to be selected and/or moved. In accordance with an embodiment of the present invention, a privacy interface application has been installed, configured and is currently in operation. In this example, the screen 206 is divided by horizontal line 207 into a lower public region 208 and an upper region 210 that provides privacy protection to programs and/or files with associated icons disposed in the upper region.

Public region 208 includes a phone icon 212 associated with making conventional voice telephone calls and a text processor icon 214 associated with a word processor. Since these icons are disposed in the public region 208, any person having access to the mobile device can access and utilize the corresponding applications.

The privacy protected region 210 includes an inbox icon 216 associated with an application that receives and stores messages addressed to the user, an outbox icon 218 associated with an application that contains messages originated and sent by the user to others, and a contacts icon 220 associated with an application that maintains a list of people and related information, e.g. email addresses, phone numbers, etc., that are relevant to the user. Since these icons are disposed in the privacy protected region 210, these applications can only be accessed/opened after a required password has been correctly entered.

The icon “My Document Files” 222 is shown in dashed lines within the public region 208 to indicate that this icon had originally resided within the public region. This icon was selected by the user using the controllable cursor, and then dragged and dropped in the privacy protected region 210 at the location indicated for icon 224. Prior to performing this operation, the user was required to have access to the privacy icons, e.g. entered the appropriate common privacy password, in order to make this change since the change involved an action related to the privacy protected region. Alternatively, the entry of an administrative privacy password can be required to be entered in order to effect a public to private or private to public status change. Thus, the documents associated with the application with the corresponding “My Document Files” icon are now subject to privacy protection and will require the entry of a valid password in order for access to be permitted. As used herein to access an application/data associated with an icon means to permit a user input directed to the associated icon on the mobile device to be conveyed to the target application/data, i.e. the middleware does not block the user input from reaching the target application/data. Assuming that the user enters a valid password, it is possible to change the application or file associated with any icon to privacy protected from public, or from public to privacy protected. In an alternative embodiment, an application or file that is publicly accessible may be indicated as having been converted to privacy protected by a change of the icon itself, e.g. changing the color, shape, etc. so as to distinguish between privacy protected and public. Both the privacy protected region 210 and the public region 208 may contain a plurality of icons such that the entire window cannot be displayed on the device screen. In order to view all of the icons in a given region, the user may be required to horizontally scroll the portion of the window shown on the screen to the left or right.

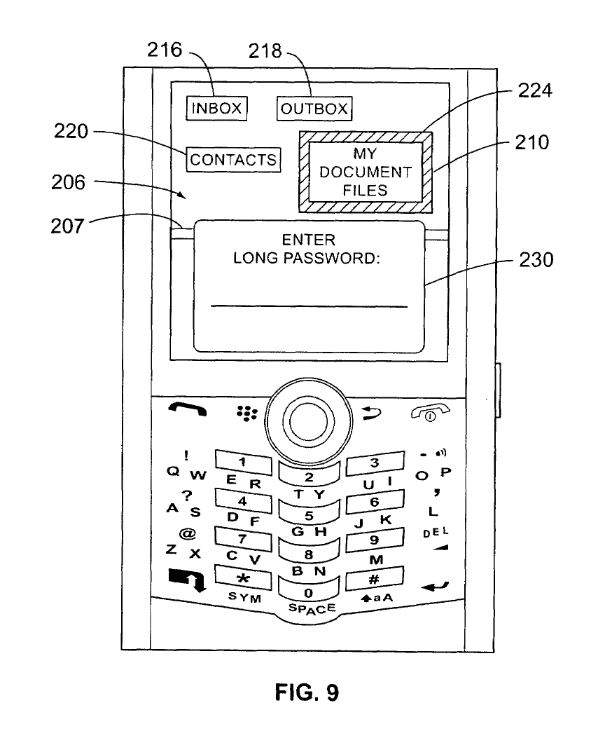

FIG. 9 is a partial front view of an exemplary mobile device in which a privacy protected item is attempted to be accessed. The icon 224 of “My Document Files” has privacy protection provided by the privacy interface application, which is visually indicated by this icon residing in the protected region 210 of the screen. The border surrounding the icon 224 indicates that this icon has been selected by the user and attempted to be opened, e.g. such as by the user highlighting the subject icon and “clicking” on it to indicate an open command. Because the folder/files associated with this icon has protection provided by the privacy interface application, the initial request by the user for access is initially routed to the privacy interface application instead of the function associated with the folder/files. In this example, the user has just turned on the subject mobile device for the first time on the given day, i.e. caused it to become powered ON from a power OFF state. As used herein a power up activation of the mobile device means the mobile device becoming powered on from a powered off state. Thus, upon the privacy interface application receiving the open icon 224 request, it causes the generation of a pop-up window 230 requesting the entry of the long password. Upon the entry of a long password, the privacy interface application will determine if it is valid by checking the entered password against the correct long password previously stored in memory. If it is valid, the privacy interface application will close the pop-up window and forward the open command for icon 224 to its corresponding folder/file function. Upon the “My Document Files” function being opened, subsequent password protection is provided as explained with regard to FIG. 6.

If the entered password is not valid, the privacy interface application will display a similar pop-up window indicating that the entered password is invalid and requesting the entry of the correct password. In one embodiment, the user is limited to a predetermined number of attempts to enter a correct password and on the predetermined number of attempts being exceeded, the privacy interface application will cause the function sought to be opened to become locked from access for a predetermined period of time and will not permit further password entry attempts during the predetermined period of time. In an alternate embodiment, the entire mobile device may be locked from access for a predetermined period of time upon the predetermined number of password attempts being exceeded. In a still further embodiment, incorrect passwords can be input an unlimited number of times without incurring any functions or the mobile device being locked from further use.

On an initial startup of the handset such as when it is started after having been turned OFF, the first attempt by the user to access an application for which privacy protection has been previously installed will result in a popup screen requesting the user to enter the long password. Thereafter, the requirement of the long/short password entry is as explained above regarding FIG. 6. The short and long passwords when correctly entered give the user access to all applications/files protected by the same privacy function. These passwords are independent of any password requirements resident within an individual application, and are valid to permit access to any of the group of privacy protected applications/files.

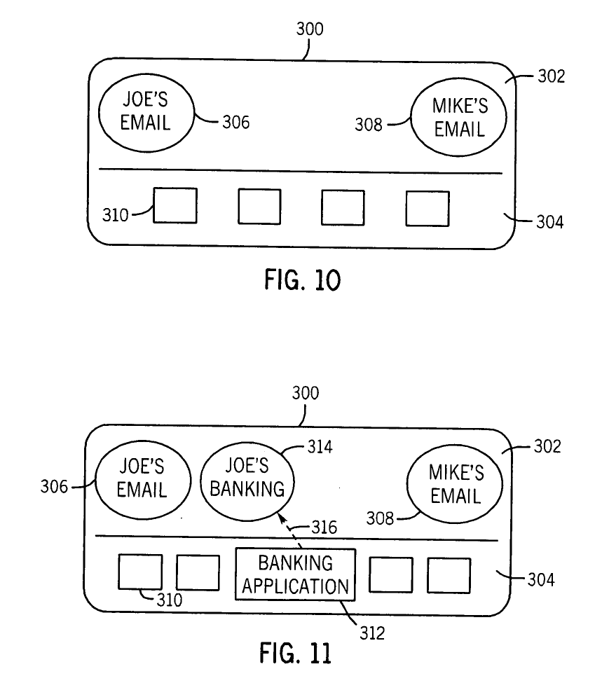

FIG. 10 shows a portion of the screen 300 of the display of a mobile device in accordance with another embodiment of the present invention. In this embodiment, two users (Joe and Mike) share the same mobile device. The screen is divided into a top portion 302 that contains privacy groups and a bottom portion 304 that contains public applications and/or files that can be accessed by anyone having access to the mobile device. In this example, one privacy group 306 contains applications and files associated with Joe's email, and another privacy group 308 contains applications and files associated with Mike's email. The privacy groups serve as privacy gates or filters that shield applications and/or files protected by it from execution and/or access, respectively, by persons who do not enter the correct password for the privacy gate. Hence, execution of or access to a program or file resident on the mobile device that is linked to (protected by) a privacy gate is inhibited until the privacy gate is traversed by the entry of the correct password. The privacy group 306 requires a password known only to Joe and the privacy group 308 contains a password known only to Mike. The lower portion 304 of the screen contains a plurality of publicly accessible applications and/or files 310.

FIG. 11 shows the portion of the screen 300 of the display of the mobile device shared by Joe and Mike, and contains the same elements described above with regard to FIG. 10. This figure further depicts the creation of another privacy group associated with Joe's bank account to be accessible only by Joe. It will be understood that the privacy interface application 81 has been previously installed on the subject mobile device. The creation of a privacy group for Joe's banking can be created as follows. Joe utilizes the mobile device to acquire a banking application 312 such as downloading it from Joe's bank or a third-party application specific provider. After acquiring the banking application 312, this application is executed by the mobile device causing it to be installed on the mobile device as a publicly accessible program. Joe, using the privacy interface application, creates a new privacy group 314 labeled “Joe's banking” and assigns a password associated with this privacy group. Once the privacy group has been created, the icon representing the banking application 312 is dragged and dropped onto the privacy group 314 as represented by the dashed arrow 316. This causes the banking application to be moved within the privacy group so that it is no longer a publicly accessible application and its icon no longer appears in the publicly accessible screen portion 304. Thereafter, access to the banking application requires a request to open the privacy group 314 which in turn will provide a displayed prompt requiring the entry of the associated password. Upon entry of the correct password, the privacy interface application causes icons associated with the applications and/or files contained in the privacy group to be displayed and permits unrestricted user interaction with these applications and/or files. Such user access is continued to be allowed to these applications and/or files until the user manually closes such access or the timeout timer associated with the privacy group is triggered.

It will be noted that the password created for the privacy group 314 is independent of passwords associated with other privacy groups on the same mobile device and of passwords that may be integrated within the applications contained within the privacy group. For example, the banking application program may include its own password protection which will have to be complied with by the user after being granted access to the application by entry of the password associated with the privacy group. Alternatively, the application program may be configured to automatically sense its presence in a configured privacy group and thereby disable its internal password requirement so that password protection provided by the privacy group is relied upon. It will also be understood that the privacy group 314 could be created prior to acquiring the banking application 312.

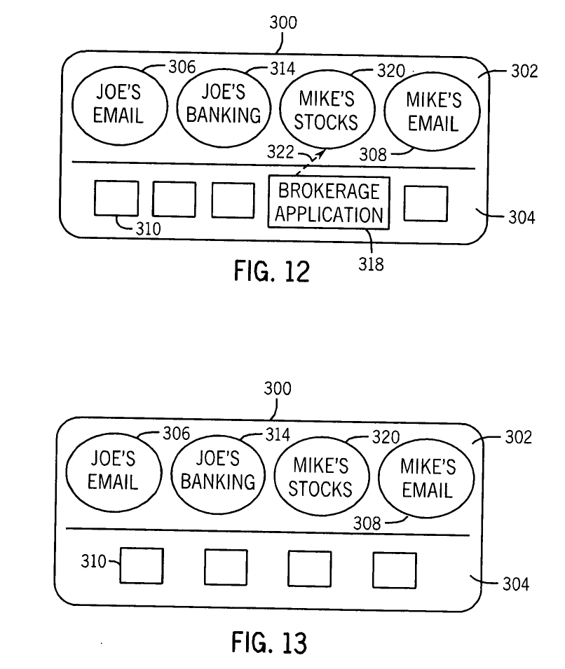

FIG. 12 is similar to FIG. 11 following the installation of the privacy group 314. This figure illustrates the creation of another privacy group, this time by user Mike, who desires to be able to access his stock account using the mobile device shared with Joe. Similar to the creation of Joe's privacy group for his banking, Mike downloads and executes the brokerage application 318 so that it is installed on the mobile device as a publicly accessible application. The brokerage application may be downloaded from the brokerage firm or may be provided by a third-party application provider. Mike then creates, using the privacy interface application, the privacy group 320 labeled “Mike's stocks” and creates the password associated with this privacy group. As indicated by the dashed arrow 322, Mike then drags and drops the brokerage application icon from the private section 304 onto the group privacy icon 320 causing the corresponding brokerage application to be contained within Mike's stocks privacy group 320 so that it is no longer accessible as a public shared item.

FIG. 13 shows the screen 300 following the creation of a banking privacy group by Joe and a stock (brokerage account) privacy group by Mike. The privacy groups provide an independent level of privacy independent of the applications and/or files associated with the respective privacy groups. Such privacy groups permit the primary user or users to share the public applications on the subject mobile device with other users or persons while maintaining certain privacy group applications and/or files inaccessible to others. It is advantageous to be able to transform applications that install by default on the mobile device for public access into applications in which privacy is provided by a privacy group.

The mobile device in one example employs one or more computer-readable signal-bearing tangible media. The computer-readable signal-bearing media store software, firmware and/or assembly language for performing one or more portions of one or more embodiments of the invention. The computer-readable signal-bearing medium for the mobile device in one example comprise one or more of a magnetic, electrical, optical, biological, and atomic data storage tangible medium. For example, the computer-readable signal-bearing medium may comprise floppy disks, magnetic tapes, CD-ROMs, DVD-ROMs, hard disk drives, flash drives and various types of electronic memory.

Although exemplary implementations of the invention have been depicted and described in detail herein, it will be apparent to those skilled in the art that various modifications, additions, substitutions, and the like can be made without departing from the spirit of the invention. For example, two or more different privacy groups could be used with one mobile device where each privacy group could be associated with a different user and where each privacy group would employ a different password known only to the corresponding user and would utilize different visual characteristics to distinguish icons in each of the different privacy groups. Or the same user can create two or more privacy groups with corresponding applications on the same mobile device, where the password for each privacy group is different or the same. Icons corresponding to the privacy groups may, but are not required to be, displayed in a defined region of the screen. Alternatively, a pre-configured program, i.e. a “skin”, can be executed on the mobile device which will automatically install a predefined privacy group with corresponding icon, where one or more application specific programs are included as part of the skin and contained within the predefined privacy group. For example, a banking skin could be downloaded and installed on the mobile device so that a predefined privacy group as well as application specific programs associated with it would automatically be installed as part of the installation of the skin so that its application specific programs would not require movement from a public accessible region into the privacy group. Various hardware, software, firmware, and combinations thereof can be used to implement the functionality and characteristics described herein for a mobile device.

The scope of the invention is defined in the following claims.

We claim:

1. A method implemented by a wireless mobile device for controlling user access to programs and files defining items that are resident on the mobile device, the method comprising the steps of:
displaying, on the screen of the wireless mobile device, a first icon associated with a corresponding first program installed on the wireless mobile device, where the first icon can be seen by any person using the wireless mobile device and the corresponding first program is available for execution to said person;
creating, using a privacy interface program installed on the wireless mobile device, a privacy gate and a corresponding privacy icon displayed on the screen;
initially entering by a first user a password associated with the privacy gate so that a subsequent request by a user to traverse the privacy gate will require entry of said password;
linking the first program and the privacy gate so that a user must traverse the privacy gate in order to execute the first program.

2. The method of claim 1 wherein the password is stored as part of the privacy gate and the privacy gate is independent of the first program prior to said linking.

3. The method of claim 1 further comprising the steps of:
displaying, on the screen of the wireless mobile device, a second icon associated with a corresponding second program installed on the wireless mobile device, where the second icon can be seen by any person using the wireless mobile device and the corresponding second program is available for execution to said person;
creating, using a privacy interface program installed on the wireless mobile device, another privacy gate and a corresponding another privacy icon displayed on the screen;
initially entering by another user another password associated with the another privacy gate so that a subsequent request by a user to traverse the another privacy gate will require entry of said another password;
linking the second program and the another privacy gate so that a user must traverse the another privacy gate in order to execute the second program;
said icons of the privacy gate and another privacy gate being concurrently displayed;
said password and the another password being different from each other so that mutually exclusive access to the first and second programs is provided to the first and another users, respectively, on the mobile device.

4. The method of claim 1 wherein the step of linking comprises the steps of dragging the first icon to coincide with the icon of the privacy gate and dropping the first icon on the icon of the privacy gate.

5. The method of claim 1 in which at least a second icon with a corresponding second program is displayed on the screen concurrently with the display of the first icon, the second program having no linkage to any privacy gate so that any person can execute the second program without having to traverse any privacy gate.

6. The method of claim 1 further comprising the step of inhibiting the display of the first icon on the screen upon the completion of the linking step.

7. An article, comprising:
one or more computer-readable tangible signal-bearing media;
means in the one or more media for installing a privacy interface program on a wireless mobile device, where the privacy interface program supports creation of a privacy gate and a corresponding privacy icon displayed on a screen of the wireless mobile device, the wireless mobile device having a first icon associated with a corresponding first program installed on the wireless mobile device, where the first icon can be seen by any person using the wireless mobile device and the corresponding first program is available for execution to said person;
the privacy interface program providing means for initial entry by a first user of a password associated with the privacy gate so that a subsequent request by a user to traverse the privacy gate will require entry of said password;
means in the one or more media for linking the first program and the privacy gate so that a user must traverse the privacy gate in order to execute the first program.

8. The article of claim 7 wherein the password is stored as part of the privacy gate and the privacy gate is independent of the first program prior to said linking.

9. The article of claim 7 further comprising:
the privacy interface program supporting creation of another privacy gate and a corresponding another privacy icon displayed on a screen of the wireless mobile device, the wireless mobile device having a second icon associated with a corresponding second program installed on the wireless mobile device, where the second icon can be seen by any person using the wireless mobile device and the corresponding second program is available for execution to said person;
the privacy interface program providing means for initial entry by another user of a another password associated with the another privacy gate so that a subsequent request by a user to traverse the another privacy gate will require entry of said another password;
means in the one or more media for linking the second program and the another privacy gate so that a user must traverse the another privacy gate in order to execute the second program;
said icons of the privacy gate and another privacy gate being concurrently displayed;
said password and the another password being different from each other so that mutually exclusive access to the first and second programs is provided to the first and another users, respectively, on the mobile device.

10. The article of claim 7 wherein the means in the one or more media for linking comprises means in the one or more media for supporting the dragging the first icon to coincide with the icon of the privacy gate and dropping the first icon on the icon of the privacy gate.

11. The article of claim 7 in which at least a second icon with a corresponding second program is displayed on the screen concurrently with the display of the first icon, the second program having no linkage to any privacy gate so that any person can execute the second program without having to traverse any privacy gate.

12. The article of claim 7 ftirther comprising means in the one or more media for inhibiting the display of the first icon on the screen upon the completion of the linking step.

13. A wireless mobile device in which user access to programs and files defining items that are resident on the mobile device is controllable, the device comprising:
a display screen;
means for displaying icons on the screen associated respectively with the items including displaying a first icon associated with a corresponding first program installed on the wireless mobile device, where the first icon can be seen by any person using the wireless mobile device and the corresponding first program is available for execution to said person;
a privacy interface program, installed on the wireless mobile device, that supports the creation of a privacy gate and a corresponding privacy icon displayed on the screen;
the privacy interface program receiving and storing a first password input by a first user where the password is associated with the privacy gate so that a subsequent request by a user to traverse the privacy gate will require entry of said password;
the privacy interface program linking the first program and the privacy gate so that a user must traverse the privacy gate in order to execute the first program.

14. The wireless mobile device of claim 13 wherein the privacy interface program stores the password as part of the privacy gate and the privacy gate is independent of the first program prior to said linking.

15. The wireless mobile device of claim 13 further comprising:
means for displaying, on the screen of the wireless mobile device, a second icon associated with a corresponding second program installed on the wireless mobile device, where the second icon can be seen by any person using the wireless mobile device and the corresponding second program is available for execution to said person;
the privacy interface program supporting creation of another privacy gate and a corresponding another privacy icon displayed on the screen;
means for entering by another user an another password associated with the another privacy gate so that a subsequent request by a user to traverse the another privacy gate will require entry of said another password;
the privacy interface program linking the second program and the another privacy gate so that a user must traverse the another privacy gate in order to execute the second program;
said icons of the privacy gate and another privacy gate being concurrently displayed;
said password and the another password being different from each other so that mutually exclusive access to the first and second programs is provided to the first and another users, respectively, on the mobile device.

16. The wireless mobile device of claim 13 wherein the privacy interface program linking comprises means for supporting the dragging the first icon to coincide with the icon of the privacy gate and dropping the first icon on the icon of the privacy gate.

17. The wireless mobile device of claim 13 in which at least a second icon with a corresponding second program is displayed on the screen concurrently with the display of the first icon, the second program having no linkage to any privacy gate so that any person can execute the second program without having to traverse any privacy gate.

18. The wireless mobile device of claim 13 further comprising means for inhibiting the display of the first icon on the screen upon the completion of the linking.
